(19) United States
(12) Patent Application Publication
(10) Pub. No.: US 2012/0118907 A1
(43) Pub. Date: May 17, 2012

(54) VENDING MACHINE-INTEGRATED TABLE

(75) Inventor: Yasushi Ochi, Osaka Prefecture (JP)

(73) Assignee: BLD ORIENTAL, CO., LTD., Izumisano City, Osaka (JP)

(21) Appl. No.: 13/382,022

(22) PCT Filed: Apr. 13, 2010
(86) PCT No.: PCT/JP2010/002657

§ 371 Date: Feb. 2, 2012

(30) Foreign Application Priority Data
Aug. 6, 2009 (JP) 2009-198944

(51) Int. Cl. G07F 11/00; A47B 37/00; G07F 9/10

(52) U.S. Cl. 221/8; 221/199

(57) ABSTRACT

The provision of the table that vending machines were united. The present invention to achieve the problem is a Vending machine-integrated table, comprising: a main body of table having at least top; and a vending machine under the top. One of a displaying and receiving means and window part is provided to the top. The displaying and receiving means is provided to the top, displaying a product which can be sold with the vending machine, and accepting an instructions from a user. The window part is viewing a product receiving area accommodated the product. And a product transporting means is provided to the vending machine, transporting the product accommodated by the product receiving area into a product takeoff opening provided in the product receiving area.

### A FIELD OF THE INVENTION

The present invention relates to vending machine-integrated table and particularly with regard to the sales system of the product, to discharge the products automatically or to sell items that will be acquired by the manual operation of the user.

### BACKGROUND-ART

As a vending machine. For example, the vertical vending machine is known as is disclosed to the following patent document currently. The conventional vending machine has coin and bill slots and a product select buttons in the upper part of the frontal perpendicular plane of the vending machine, and downwardly there are a product dispensing and a change dispensing. And a product is replenished in a product stock storage provided on the frontal door back side of the main body of vending machine inside and the vending machine. Thus, the user who is going to purchase a product pay a fare, in a standing position, and a product is selected from a vending machine, and next, the user stoops down, and change takes out a product from a downward product dispensing, and change will be taken out from a change dispensing.
Patent Document 1: Japanese Unexamined Pat. App. Pub. No. 2002-133,492

### DISCLOSURE OF INVENTION

### Problem Invention is to Solve

As noted above, the vending machine described in the related art was formed in the vertical appearance from ease of the production, and from ease of the transportation. Thus, the conventional vending machine is often installed outdoors and even if it is installed indoors, it is necessary to install in the wall surfaces, and there was not to be installed central of the room (Of course, it would take up a lot of room for installing vending machines in the middle of the room, etc.).

That is, for conventional vending machine, an exclusive domain was necessary when a predetermined domain (the domain for exclusive use of the vending machine) that faced the outdoors or the wall could not be found to install a vending machine, a conventional vending machine was not able to be installed

On the other hand, there is a request to increase further the location of the vending machine for setting users such as the drink makers which wanted to make a vending machine installed.

### SUMMARY OF THE INVENTION

### Problem Invention is to Solve

The present invention to achieve the problem is a Vending machine-integrated table, comprising: a main body of table having at least top; and a vending machine under the top. One of a displaying and receiving means and window part is provided to the top the displaying and receiving means is provided to the top, displaying a product which can be sold with the vending machine, and accepting an instructions from a user. The window part is viewing a product receiving area accommodated the product. And a product transporting means is provided to the vending machine, transporting the product accommodated by the product receiving area into a product takeoff opening provided in the product receiving area.

As noted above, the exclusive domain that, was necessary by conventional art is not necessary because a table is integrated with a vending machine. If there is a domain to install a table in, vending machine-integrated table of the present invention can be installed in the domain. Thus, vending machine-integrated table of the present invention can be installed to the place where a vending machine was not able to be installed in because there were not the domains for exclusive use of a thing of a vending machine such as near wall surfaces.

The vending machine-integrated table of above aspect provided in the displaying and receiving means, it is desirable that the displaying and receiving means is configured to display the state that a product accommodated by the product receiving area is transported to the product takeoff opening when the displaying and receiving means accepts the instructions from a user the vending machine-integrated table of claim above aspect it is desirable further comprising an indication instructions means directing to display the product which can be sold with the vending machine to the displaying and receiving means. When it is not used as a vending machine, it prevents it from displaying any initial screen or screen, and it can be functionalized as a vending machine when a user is necessary The vending machine-integrated table of an aspect which a window part was comprised to the top, it is desirable further comprising a shutter provided in the top, changing the product receiving area from the window part, from the state being impossible of viewing to the state being possible of viewing. When it is not used as a vending machine by doing in this way a product receiving area is done in viewing impossibility, and it is only used as a table.

The vending machine-integrated table of an aspect which a window part was comprised to the top, it is desirable further comprising a rail for the internal circumference of the product receiving area; and wherein the product transporting means includes a support moving along the rail by the operation of the user. And it is desirable comprising a holding means provided on the support, moving over the support, be hung up-and-down motion operatively, and holding a product accommodated by the product receiving area.

As noted above, the user can operate product transporting means, at first the support which hung holding means is moved to the neighborhood of the product which a user hopes for along a rail. And the holding means is moved over a support to right above product. Even more particularly, holding means descends, and the product is held, and a held product will be transported to the product, takeoff opening provided in the product receiving area.

The vending machine-integrated table of claim 1 or 4 which a window part was comprised to the top, it is desirable that the horizontal section shape of the product receiving area is circular; a rail for the internal circumference of the product receiving area. And the product transporting means includes: a axis provided the center of the product receiving area, and be rotatable by the operation of the user; a support pivotally supported by the axle, moving along the rail, and having a length corresponding to the horizontal distance from the axis to the rail; and a holding means provided on the support, moving over the support, be hung up-and-down motion operatively, and holding a product accommodated by the product receiving area.

The vending machine-integrated table of an aspect wherein the holding means comprises a pair of pick-shaped members gripping the product. And the vending machine-integrated table of an aspect wherein the holding means comprises a shovel-shaped member scooping the product, and gripping. And the vending machine-integrated table of an aspect wherein the holding means comprising: a pump flowing out or flowing into of the air: a hose that one end was connected to the pump. And a tool for absorption is connected to the another end of the hose, being configured to be enabled to flow out or flow into of the air, being configured to be enabled to absorb the product from a tip of the tool for absorption through the hose.

The vending machine-integrated table of as aspect which a window part was comprised to the top, wherein the product transporting means comprising: a conveyer rail provided in product receiving area, driven by an endless conveyer. And a extrusion means extrude a product designated by user to a product takeoff opening, when a product designated by user transported near the product takeoff opening product among located to the conveyer.

Also, product transporting means include an axis provided with the product receiving area and a turn board and an extruded means. In this case, a turn board pivotally supports an axis, and the turn board a rotates, and a extrusion means extrude a product designated by user to a product takeoff opening, when a product designated by user transported near the product takeoff opening product among located to the rotary board.

To a sale object that dessert such as the cakes and the foodstuffs which a shape is changed into when got, and scooped by holding means, and absorbed with air. For example, the foodstuffs are put in boxes, and the box which foodstuffs were put in is located to the turn board. And the turn board a rotates, and a extrusion means extrude a product designated by user to a product takeoff opening, when a product designated by user transported near the product takeoff opening. The product can be transported without breaking a shape.

The vending machine-integrated table of an aspect it is deserable further comprising a leg portion provided to the main body of table, and a seat provided to the leg portion.

A seat (a chair) is not separated from the main body of table, because a seat is comprised in the main body of table as noted above. Thus, it is not necessary to put the chairs corresponding to the seat in order, after using vending machine-integrated table of the present invention. Therefore, the product can be sold to a user (a visitor) by vending machine-integrated table of the present invention when servicemen's waiting on customers are few (it may be the unmanned sale that there is not a serviceman).

### An Effect of the Invention

The exclusive domain that was necessary by conventional art is not necessary, because a table is integrated with a vending machine. If there is a domain to install a table in, vending machine-integrated table of the present invention can be installed in the domain. Thus, vending machine-integrated table of the present invention can be installed to the place where a table can be installed in even if a vending machine was not able to be installed in because there were not the domains for exclusive use of a thing of a vending machine such as near wall surfaces.

### BRIEF DESCRIPTION OF DRAWINGS

FIG. 1 is a figure showing the whole constitution of the vending machine concerning the embodiment of the present invention-integrated table.

FIG. 2 is a figure of vending machine concerning the embodiment of the present invention-integrated table top.

FIG. 3 is a figure showing the operating member which the side of the vending machine concerning the embodiment of the present invention-integrated table was provided with.

FIG. 4 is a figure when the operating member is established in the vending machine concerning the embodiment of the present invention-integrated table top.

FIG. 5 is a figure showing the whole constitution of the vending machine concerning the embodiment of the present invention when a circle-shaped product receiving area was adopted-integrated table.

FIG. 6 is a figure showing the product transporting means such as an arm shape, a shovel-shaped shape, and a pumping mechanism, regarding a vending machine concerning the embodiment of the present invention-integrated table.

FIG. 7 is a figure showing product transporting means comprising the extruded means, regarding a vending machine concerning the embodiment of the present invention-integrated table.

FIG. 8 is a figure showing the control system hardware configuration of the vending machine concerning the embodiment of the present invention-integrated table.

FIG. 9 is a function block diagram of the vending machine concerning the embodiment of the present invention-integrated table.

FIG. 10 is a flow chart of the handling of at the time of the product acquisition of the vending machine concerning the embodiment-integrated table present invention.

FIG. 11 is a figure showing the example of a screen displayed by the top of the vending machine concerning the embodiment of the present invention-integrated table.

FIG. 12 is a flow chart of the handling of at the time of the product acquisition of the vending machine concerning the embodiment-integrated table present invention.

FIG. 13 is a figure showing the use state of the vending machine concerning the embodiment of the present invention-integrated table.

FIG. 14 is a figure showing the use state of the vending machine concerning the embodiment of the present invention-integrated table.

FIG. 15 is a figure showing the use state of the vending machine concerning the embodiment of the present invention-integrated table.

### A FORM TO CARRY OUT INVENTION

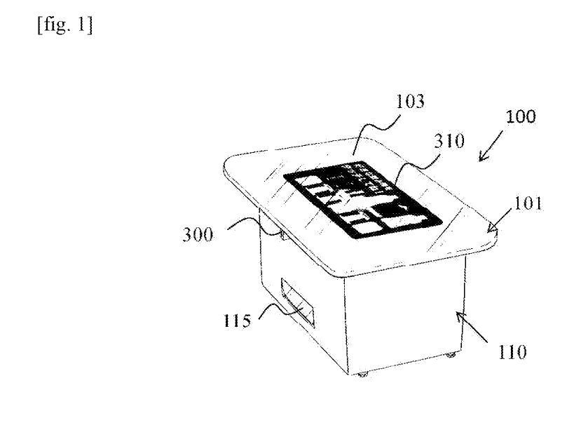

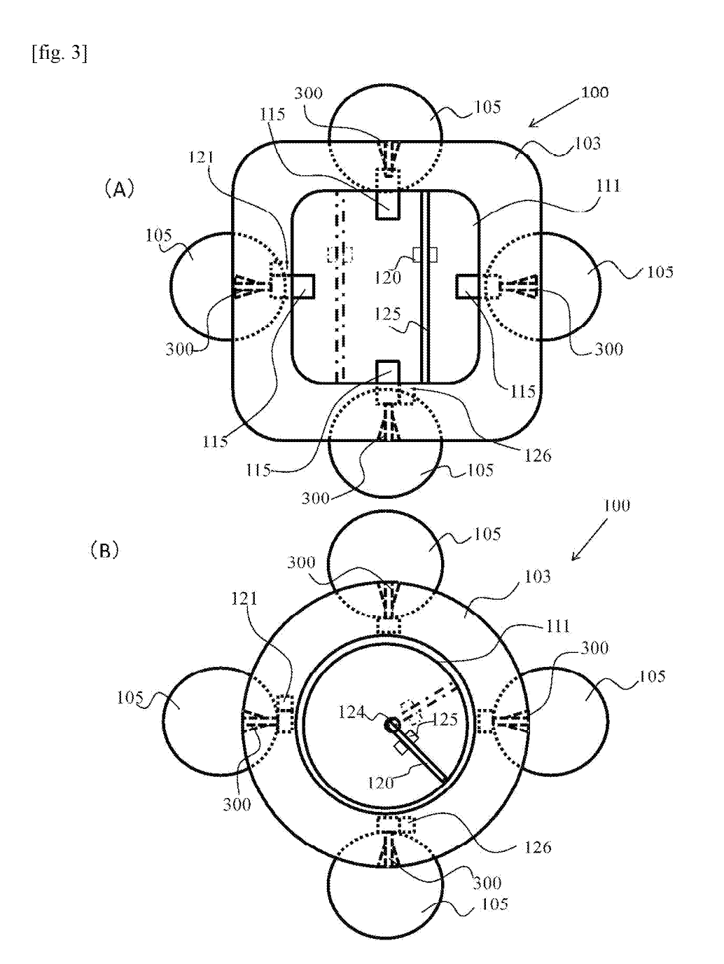

Handling of basic product export of vending machine-integrated table 100 of the present invention is described below. FIG. 1 is an outline schematic block diagram of vending machine-integrated table 100 of the present invention. However, the details of the all parts which do not directly-relate to the present invention are omitted. When a user purchases a product using vending machine-integrated table 100 of the present invention, paper money and a coin (even if it is the coin which an installation personnel of vending machine-integrated table 100 established originally, of course it does not mind.) which are necessary for the product purchase are cast into slit 330 shown in FIG. 3, and the product purchase is instructed to operating member 300 provided in top 103 lower part of vending machine-integrated table 100. When there are the instructions, the product dispensing of the selected product is performed because all parts (a driving member) shown below work.

That is, as shown in FIG. 1, vending machine-integrated table 100 of the present embodiment comprises main body of table 101 and vending machine 110 attached the main body of table 101. Display panel 310 is provided at top 103 of main body of table 101. For example, display panel 310 is comprised in touch panel, and a desired product can be selected when a user pushes down a product shown display panel 310.

Product select buttons and the feature of the product to select a product contained in product receiving area 111 as will hereinafter be described, a function to display the advertisement about the product and a function to accept the click of displayed product select buttons are comprised in the touch panel included to top 103. That is, by pushing down the button (the, e.g., product select buttons) in a screen displayed by touch panel, processing conditions associated with the button pushed down are input.

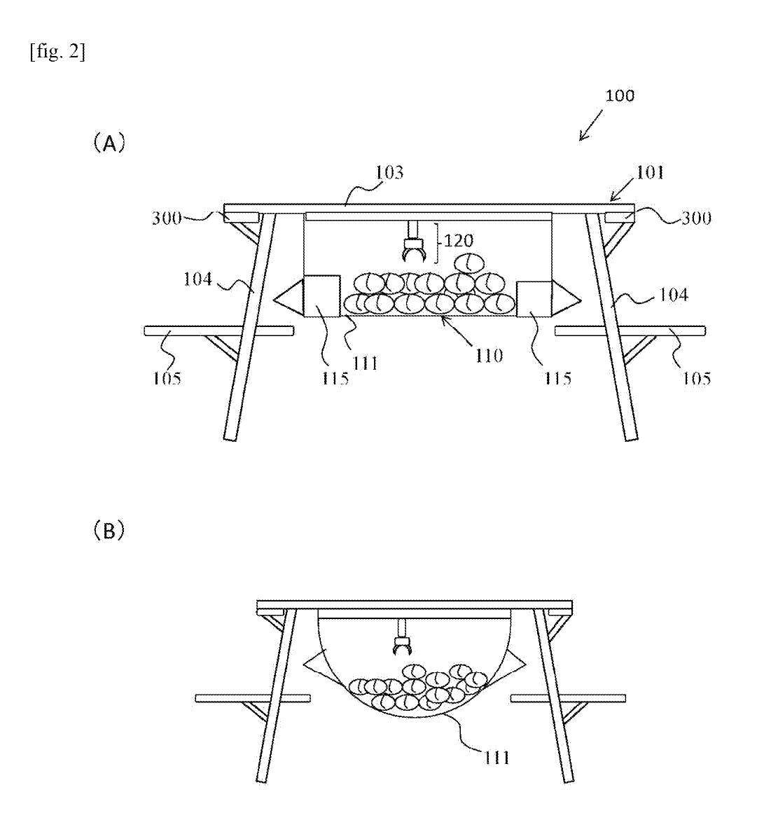

Touch panel can adopt constitution to display an animation in imitation of the state that a product is transported other than the product select buttons. For example, component to display the state that a product is transported (as will hereinafter be described) can be adopted. Top 103 can adopt the component comprising the window part as shown in FIG. 2 as substitute for the display panel. That is, after the opening was provided to the top 103 of main body of table 101, and having engaged the opening and the product receiving area 111 of vending machine 110, the component comprising the cover of product receiving area 111 is adopted, on the top 103 upper opening. It may be configured that the non-transparence closes the cover so that product receiving area 111 is not visible, but the present embodiment adopts constitution to close the transparence cover that the product is visible. The transparence cover is equivalent to the window part of the present invention. Even more particularly, the cover of the opening of the top may comprise removably to be able to contain a target product from an opening of top 103 in product receiving area 111.

Top 103 of main body of table 101 does not consider the shape, it may be form of rectangular, or circle as shown in FIG. 2 (B). Also component to comprise a shutter to change in the state that is impossible of viewing from the state that viewing is possible may be adopted on the top. Main body of table 101 can adopt component comprising a plurality of leg portion 104 to support top 103. In the case of the above, seat 105 for chairs is fixed to the given point of leg portion 104. In accordance with exemplary embodiments, the hole is established in seat 104 formed of a predetermined shape (for example, circular), and above seat 105 is fixed to leg portion 104 by engaging hole and leg portion 104. It does not mind that it is comprised pivotally to seat 105 leg portion 104.

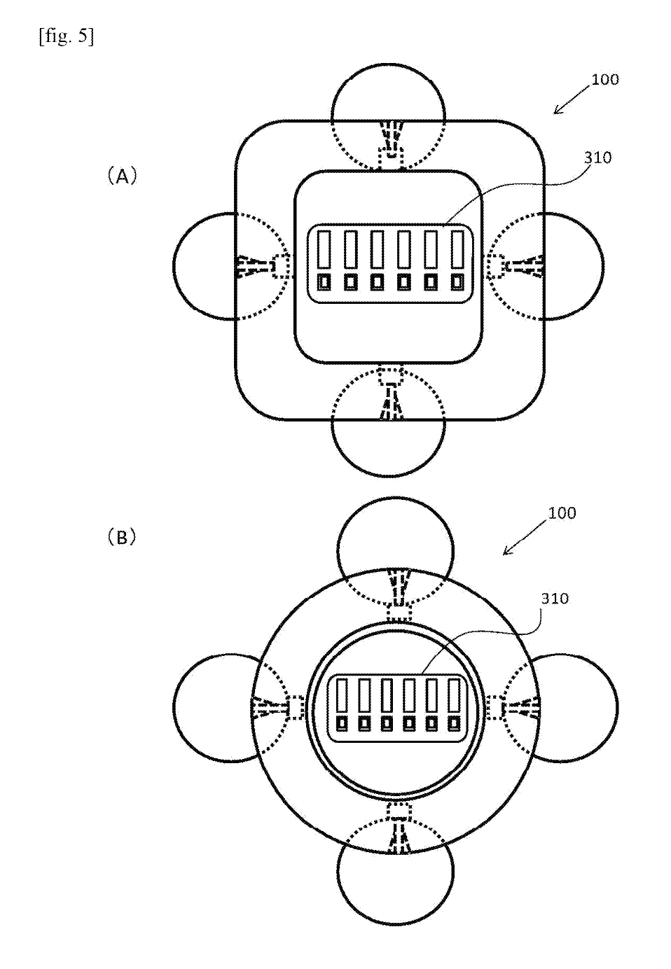

As shown in FIG. 2, 4, operating member 300 is comprised the circumference around top 103 of main body of table 101. Operating member 300 is provided with display panel 310 comprising indication area 311 displaying the specimen of a product becoming the sale object, and product select buttons 312 that the product corresponding to the specimen product is selected to purchase, and it is also provided with cash slit 330 by the common cash sale, a return lever (it is not illustrated). Also, as shown in FIG. 5, component comprising operating member 300 in the top 103 top surface can be adopted.

Even more particularly, product receiving area 111 is provided with product takeoff opening 115 to take out a transported product. Vending machine 110 provided in the lower of main body of table 101 comprises product receiving area 111 and product transporting means 550 as will hereinafter be described, and operating member 300. The product receiving area 111 is a container to accommodate a product for the sale, a container of the transparence is used so that user can view a product contained in product receiving area 111 from the outside as shown in FIG. 2. The shape of product receiving area 111 is arbitrary in FIG. 2 (A), rectangular solid-shaped product receiving area 111 is shown, and, in FIG. 2 (B), hemispheric product receiving area 111 is shown. Also, product takeoff opening 115 to take out a product transported with product transporting means 550 as will hereinafter be described is comprised in the bottom of product receiving area 111. Also, because the details of the all parts which naturally are necessary for the vending machine public such as the temperature maintenance mechanism to store a product at predetermined temperature have nothing to do with the present invention, explanation, the illustration are omitted.

The method that vending machine 110 transports a target product from product receiving area 111 to product takeoff opening 115, may use the transportation method of the well-known vending machine, and the method used for the well-known gaming machine which is described below may be used. Also while a user does product selection, an animation which showed the state that following product transporting means 550 transported a product transporting means 550 transported a product can be displayed to display panel 310 on the top 103.

Here, it is product 550 that among products contained in product receiving area 111, either one product is selected by the instructions of the user, and transport the selected product to the product takeoff opening 115 mounted to the vending machine 110. Product transporting means 550 can use the transfer mechanism of the arm to grip the product, for example used for the well-known gaming machine. The vending machine-integrated table 100 is equipped with an arm support movement motor 126 to move arm support 125 in support of arm 120, and an arm movement motor 121 moving arm 120. Here, the upper end internal circumference of product receiving area 111 is provided with a rail (do not illustrate) for arm support 125 to move. The arm support 125 will move on the rail.

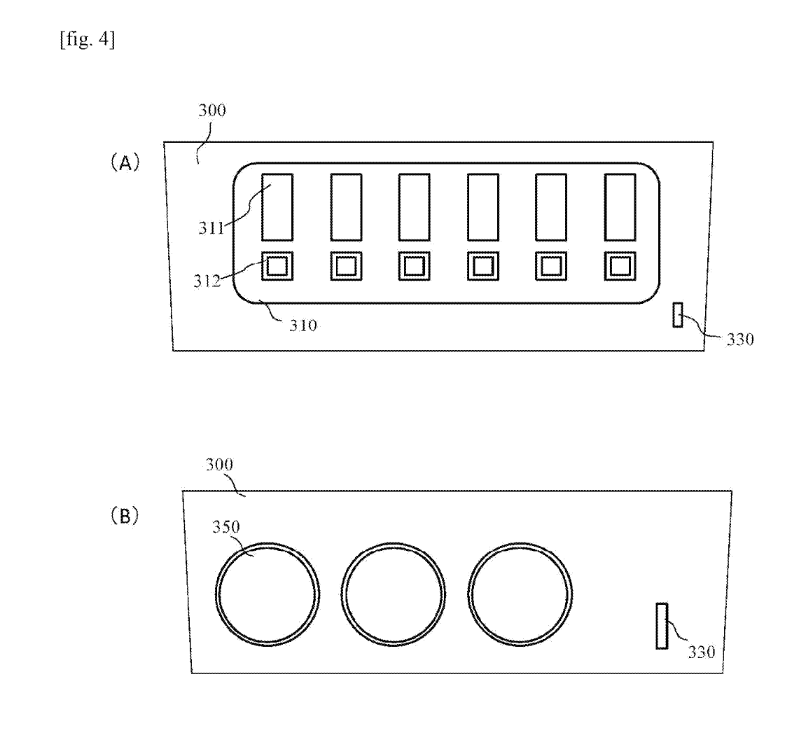

The planar positioning operation is carried out by drive transmission to be coupled with both movement motor. At first, by arm support movement motor 126, arm support 125 moves to the depth direction of vending machine-integrated table 100, or move from the right to the left laterally along the rail. Then, positioning of the arm going up and down position is accomplished because arm movement motor 121 moves arm 120 along arm support 125. Note that, among transfer mechanisms of arm 120, explanation and the illustration of the other parts usually provided with a transfer mechanism such as a belt member, a pulley, are omitted. Furthermore, as shown in FIG. 4 (B), operating a button 350 that is provided to operating member 300 can move arm support 125 and arm 120.

As illustrate in FIG. 3(B), When circle-shaped (circular a horizontal section shape) product receiving area 111 is adopted, the configurations of other transfer mechanisms of product transporting means 550 can be employed. For example, axis 124 is established in the center of circle-shaped product receiving area 111, and the circumference direction of product receiving area 111 is positioned first by turning arm support 125 rotating around axis 124. Then, positioning of arm 120 of the radial direction can be performed by moving arm 120 from the center of arm support 125 to a radial direction. Furthermore, in the present embodiment, the length of arm support 125 uses a radius (length corresponding to the horizontal distance from axis 124 to a rail) when product receiving area 111 was regarded as the top surface. Arm support 125 pivotally support one end of in axis 124, and the another end of it is supported by a rail established in product receiving area 111. Of course the length of arm support 125 can use the length of the diameter of product receiving area 111.

Even if the axle is not comprised, arm support 125 can be positioned at the circumference direction of product receiving area 111. For example, the driving wheel to move on the rail is provided to the both end portions of arm support 125 (in this case arm support 125 will have the length for the diameter of product receiving area 111), (it goes without saying that the driving wheel provides at the position located on the rail.). And arm support 125 can be moved along a rail by driving the driving wheel.

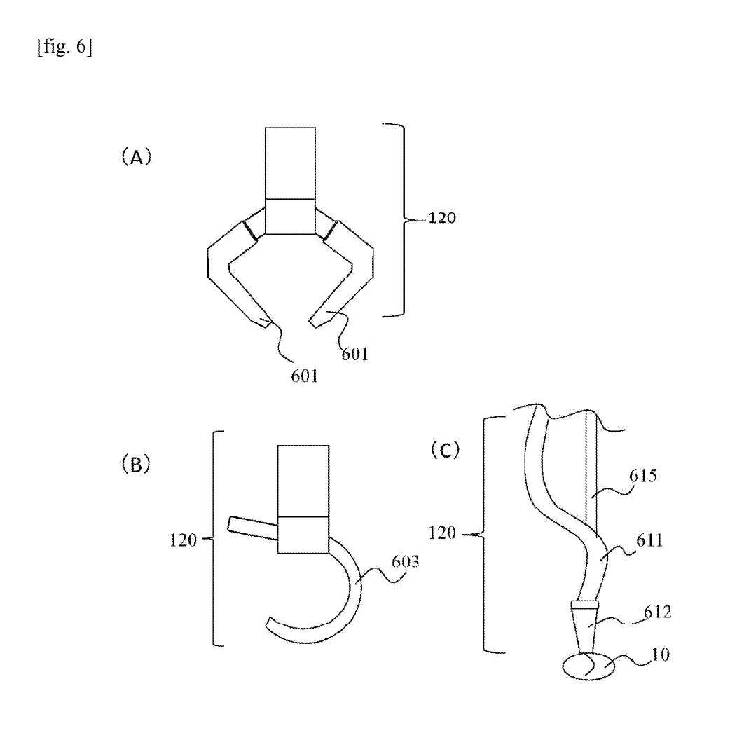

Note that the method that arm 120 catches a target product can adopt the configuration that the arm used for the well-known gaming machine catches a premium (corresponding to the target product of the present embodiment). For example, as shown in FIG. 6 (A), pick-shaped member 601 which a product is caught, and/or thrown on is attached to the tip of arm 120. Furthermore, the arm 120 is provided with a motor as the power source, and arm opening and closing mechanism (which is not illustrated) the arm is opened and closed based on the rotary output of and this motor and having racks and pinions, and by rotation in the normal direction or a reverse rotation driven thing, opening and shutting of arm 120 is performed.

Even more particularly, configuration a product is scooped by a shovel-shaped member as configuration other than arm 120, and to do the acquisition (holding) can be adopted. Even more particularly, a pumping mechanism 610 can be used as shown in FIG. 6 (C). For example, tool for absorption 612 is provided to one end of hose 611. The other end of hose 611 is connected to the pump which does not illustrate. And then it is configured to absorb a product because the flowing out or flowing into of the air through an above hose is possible by the operation of the pump from the tool for absorption 612 tip.

Also, when a target product adheres, for example, to a magnet, after having positioned the electromagnet as above by adopting an electromagnet replacing with arm 120, an object product can adopt configuration to adhere to the electromagnet by sending an electric current to an above electromagnet. In addition, when, such as cakes (of course the box (referred to as merely box as follows) which cakes were put in will be contained in the product receiving area.), the shape transports the product which is easy to collapse by catching and picking up, the box can be transported from the product receiving area to a product takeoff opening as follows.

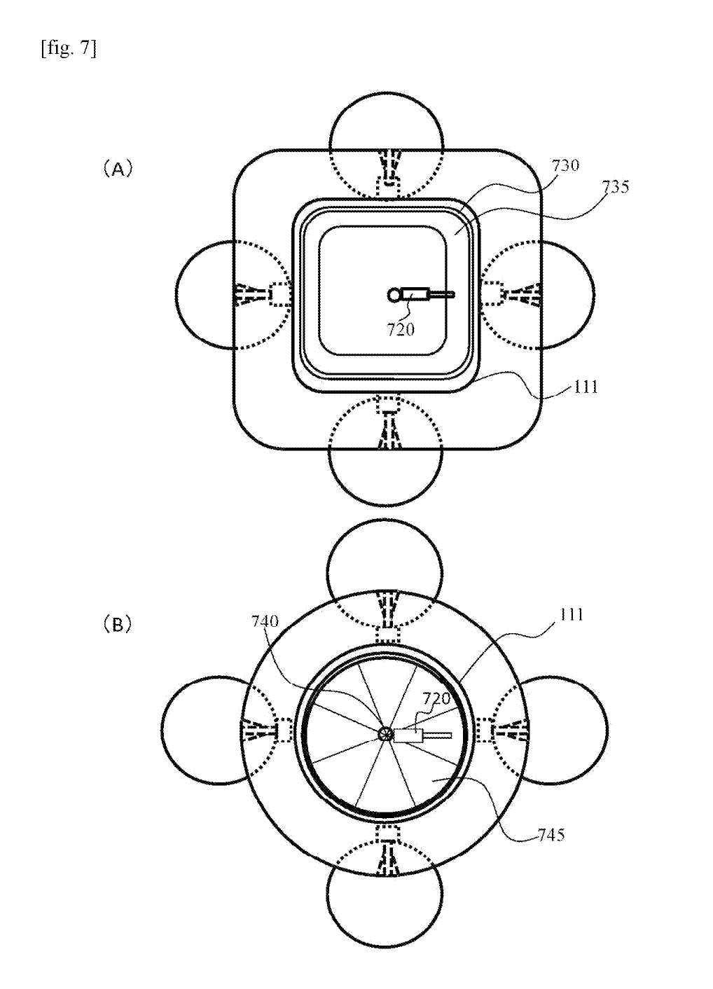

That is, for example, as shown in FIG. 7 (A), conveyer rail 730 is provided to product receiving area 111 if the shape of conveyer 735, as will hereinafter be described, is a locatable shape, the shape is arbitrary). The conveyer rail 730 is provided to drive an endless conveyer 735. The product which the shape such as the cake box is easy to be changed into is located on conveyer 735 of course even the product which a shape is hard to be changed into is not minded). And the product receiving area 111 is provided with elastic extrusion means 720, when conveyer 735 of conveyer rail 730 is driven, and among products located to conveyer 735, the specified product is transported to the product takeoff mouth around, with elastic extrusion means 720 is configured to extrude a product of the product takeoff opening around to a product takeoff opening. In accordance with exemplary embodiments, extruded means 720 is provided to the vicinity of the center of product receiving area 111.

Even more particularly, an alternative embodiment comprising extruded means 720 is shown in FIG. 7 (B). At first, product receiving area 111 is formed to a circle, and axis 740 is provided to the product receiving area 111. And a board 745 pivotally supports the axis 740. A rotary board 745 is disposed a given number of cake boxes. In accordance with exemplary embodiments, it is divided around rotary board 710 in a plurality of domains, and configured to dispose the box which cakes were contained in, in each divided domain.

Even more particularly, extruded means 720 is provided to the vicinity of 710 rotary board center. When the box (it goes without saying that it is a designated box by a user.) is transported from the appointed position to the product takeoff opening 115 around, this extruded means 720 extrudes the box, and to move to the product takeoff opening 115. The extruded means 720 may be provided with an each extrusion means 720 which it moves a box from before “product takeoff opening 115 to product takeoff opening 115, at the position opposed to each product takeoff opening 115 (equivalent in the vicinity of the center of rotary board 720). Alternatively, the extruded means 710 is configured to be able to rotate axis 701 as an axis, when a box is transported to one product takeoff opening 115 neighborhoods, extruded means 710 rotates axis 701 around, and moves to the opposed position to one product takeoff opening 115.

When rotary board 710 rotates, among products located to rotary board 710, the product which a user specified is transported to product takeoff opening 115 around, extrusion means 710 of the above configuration can push out a product of product takeoff opening 115 around to product takeoff opening 115.

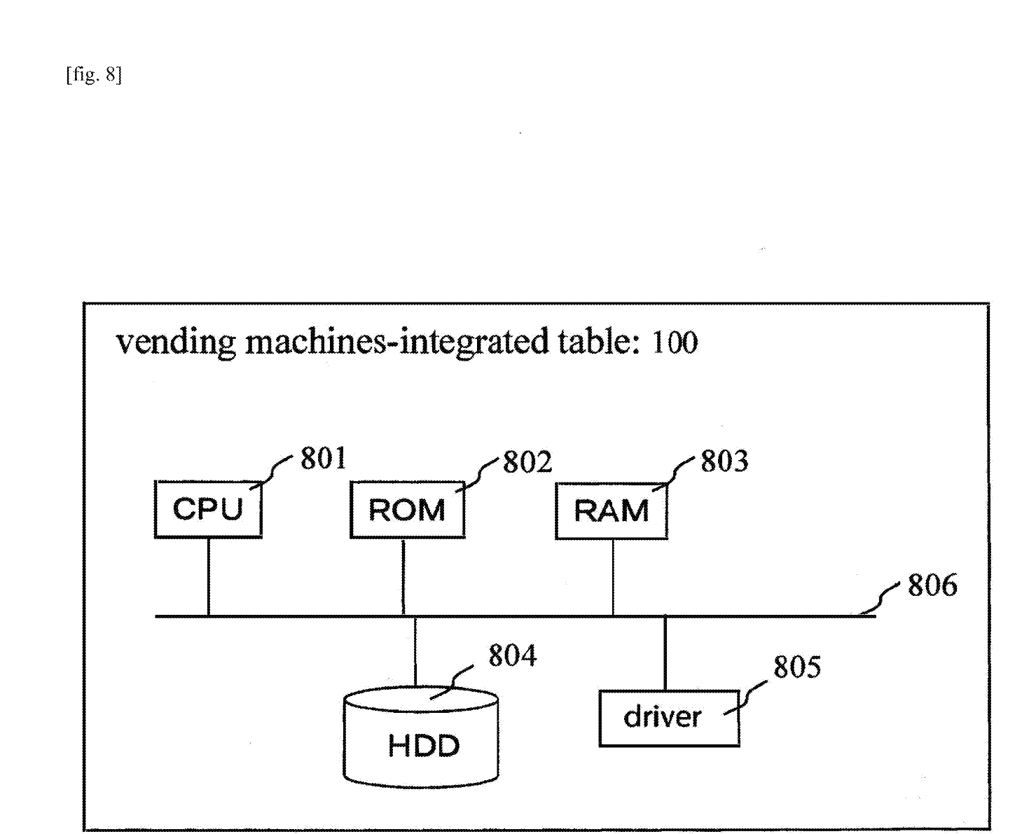

Then, using FIG. 8, a control system hardware configuration of vending machine-integrated table 100 of the present invention is described. FIG. 8 is an illustration of outline constitution of the control system hardware in vending machine-integrated table 100. However, the details of the all parts which do not directly relate to the present invention are omitted. The control circuit of vending machine-integrated table 100 connects CPU (Central Processing Unit) 801, ROM (Read Only Memory) 802, RAM (Random Access Memory) 803, HDD (Hard Disk Drive) 804, driver 805 corresponding to each drive by internal bus 806. For example, RAM 803 is used as working area, and a program stored by ROM 802, HDD 804 is performed, and driver 805 and the data from the operating member, instructions are delivered based on the practice result, and CPU 801 controls the movement such as each illustrated drives.

(Flow 1 of the Processing at the Time of the Product Transportation)

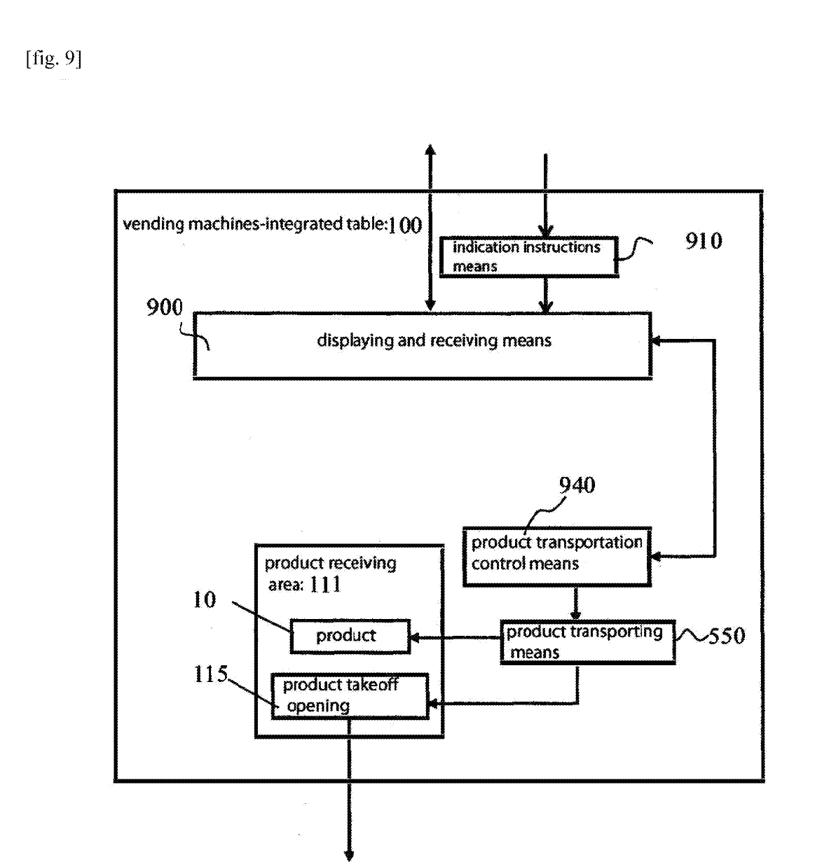

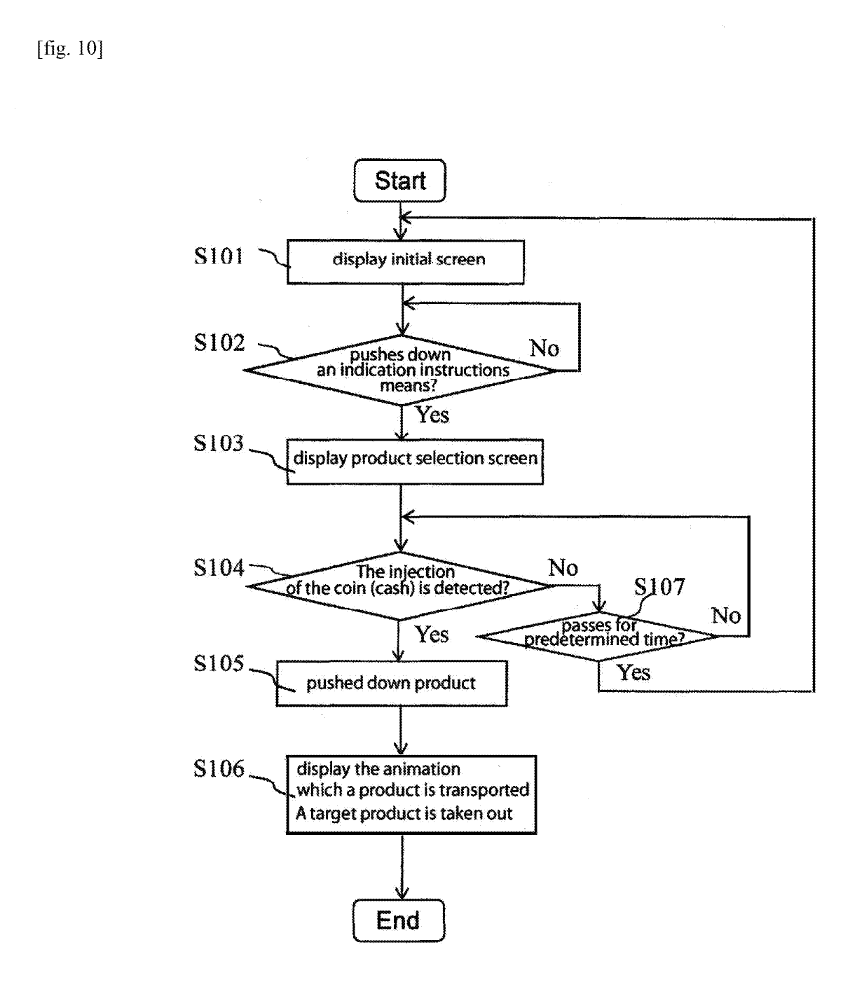

Next, handling of at the time of the product transportation of vending machine-integrated table 100 present invention is described referring to the drawings. FIG. 9 is a function block diagram of vending machine of the present invention-integrated table 100, FIG. 10 is a flow charts showing the processing at the time of the product sorting of vending machine of the present invention-integrated table 100. Note that S shown in FIG. 10 means a step.

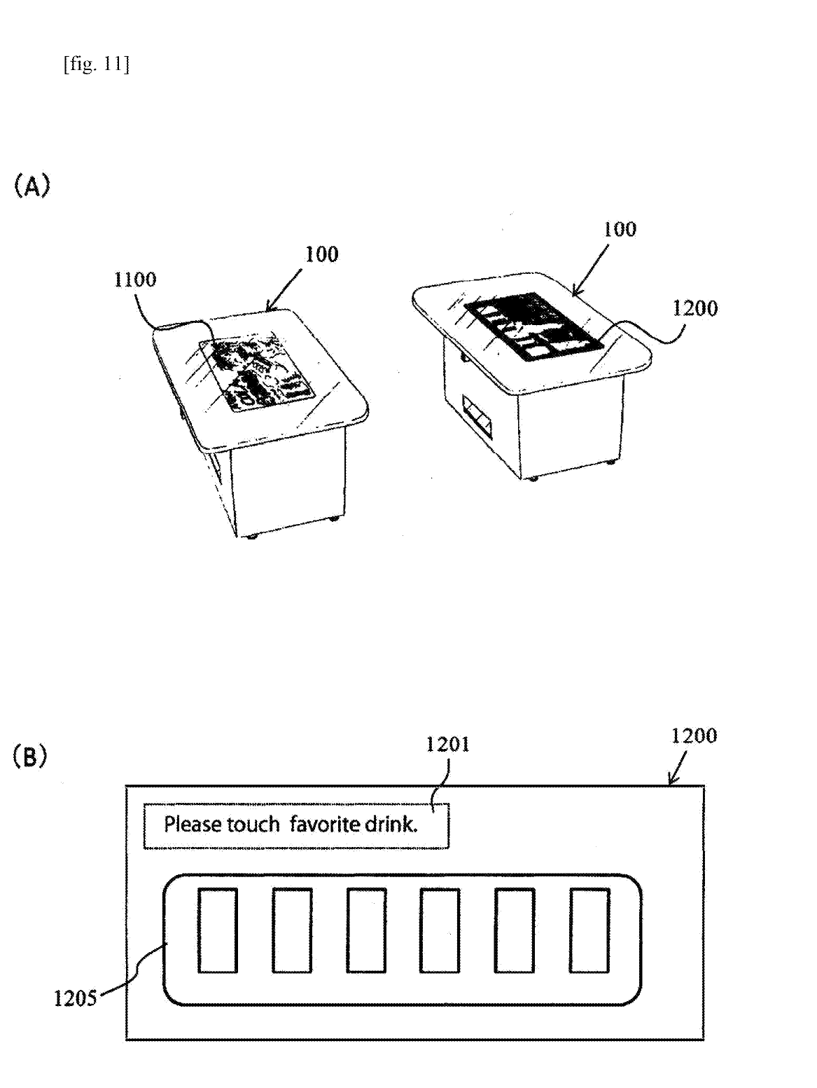

At first, displaying and receiving means 900 is provided to the top 103, displays initial screen 1100 to display panel 310 (FIG. 10:S101). Initial screen 1100 may display any still image or animation. Alternatively, the configuration that does not display the image can be adopted to use as a table. In accordance with exemplary embodiments, configuration to make an advertisement animation shown in FIG. 11 displayed for initial screen 1100 is adopted. When the user who wants to purchase a product pushes down a changing-over switch in the invention-integrated table of the present invention (configuration for operating member 300 of the backside of top 103 can be adopted), indication instructions means 910 accepts this (FIG. 10: S102YES), and displaying and receiving means 900 is notified of displaying a product selection screen. Note that, in substitution for a changing-over switch, constitution for example, a money slit is provided to the backside of top 103 and a user cast money into the money slit is detected (it is described below), and above displaying and receiving means 900 is configured to notify of indication instructions means 910 displaying a product selection screen.

As noted above, when it is notified that indication instructions means 910 makes product selection screen 1200 displayed, indication receptionist, means 900 changes displayed currently initial screen 1100 to product selection screen 1200 that the product purchase is possible, (FIG. 10:S103). The product selection screen 1200 displays a message 1201 according with a user by the selection of the product, and also displays a product image 1205 in imitation of a commercially-available product.

When the product which user wants to purchase is determined, and the user casts the cash (even the predetermined coins which an installer of vending machine-integrated table 100 established in substitution for cash are not minded) which can purchase the product which a user determined, into an above money slit at product selection screen 1200, the displaying and receiving means 900 can push down the product image corresponding to the available for purchase product in the range of the money (it can be purchased). For example, an above product can be purchased by turning on the backlight of the product image which can be purchased, by indication receptionist means.

Then, when product image 1205 corresponding to the product which a user wants to purchase is pushed down, displaying and receiving means 900 accepts this (FIG. 10: S105), and product transportation control means 940 is notified of transporting the product pushed down to product takeoff opening 115. As a result, product transportation control means 940 controls product transporting means 550, and product 10 will be transported to a product takeoff opening, and displaying and receiving means 900 adopts constitution to make a display panel display the animation which a product is transported to from product receiving area 111 to product takeoff opening 115 (FIG. 10: the S106→end). Displaying and receiving means 900 will make a display panel display the animation by referring to the animation memory means that stored the animation.

Note that, when money is not spent, even if a screen is displayed; and it passes for predetermined time, displaying and receiving means 900 will change product selection screen 1200 to initial screen 1100, (FIG. 10: S104NO→S107→S101).

(Flow 2 of the Processing at the Time of the Product Transportation)

Although, the configuration which transported object product 10 contained in product receiving area 111 to product takeoff opening 115 automatically was adopted in the flow 1 of the processing. In contrast, configuration by transporting product 10 to product takeoff opening 115 by the operation of the user (manually operated operation) can be adopted.

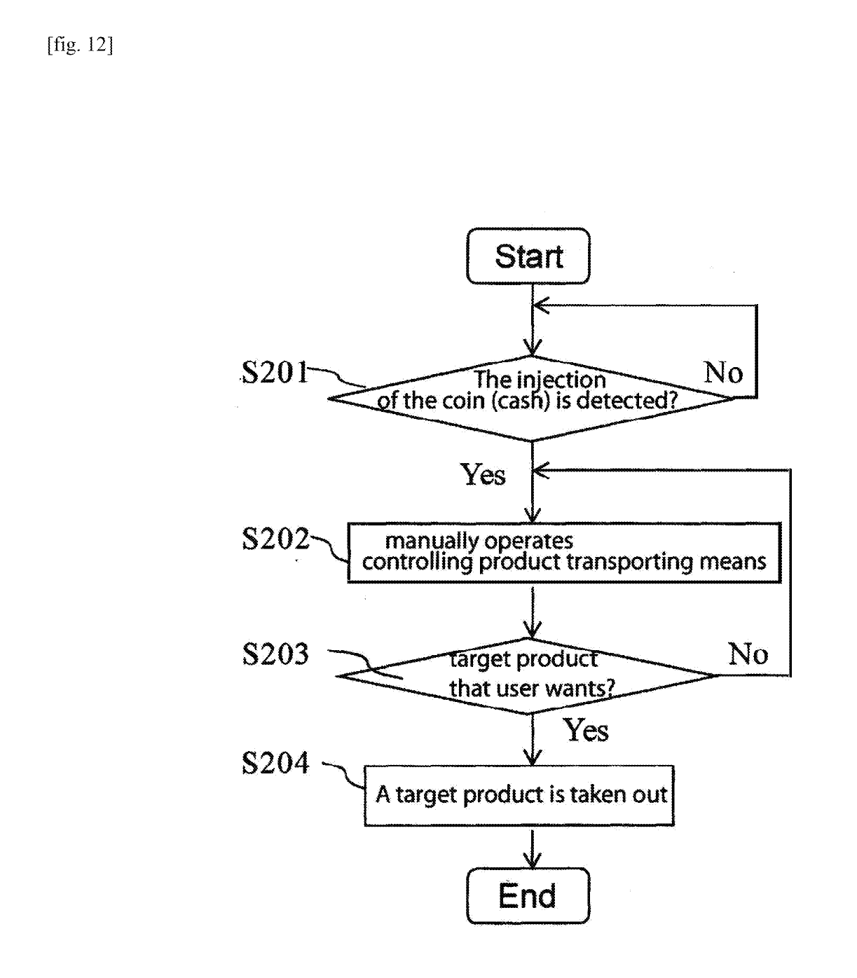

Vending machine-integrated table 100 of the present embodiment is provided with the window part that viewing is possible from top 103 in a product receiving area. When the user who wants to purchase a product casts cash into a money slit, like detailed description of the preferred embodiment 1 (FIG. 12: S201YES), displaying and receiving means 900 accepts this, and above-mentioned product transporting means 550 can be controlled. A user manually operates an operating member (corresponding to product transportation control means 940) controlling product transporting means 550 that displaying and receiving means 900 was provided to (FIG. 12: S202). The control signal from the operating member is notified to product transporting means 550, and this is undergone, product transporting means 550 will transport the product 10 to a product takeoff opening by the user operation (FIG. 12: the S203YES S204 end). In this case, the configuration that operation of product transporting means 550 is enabled again and again can be adopted until a predetermined product is acquired (FIG. 12: S203N0 S202).

(Others)

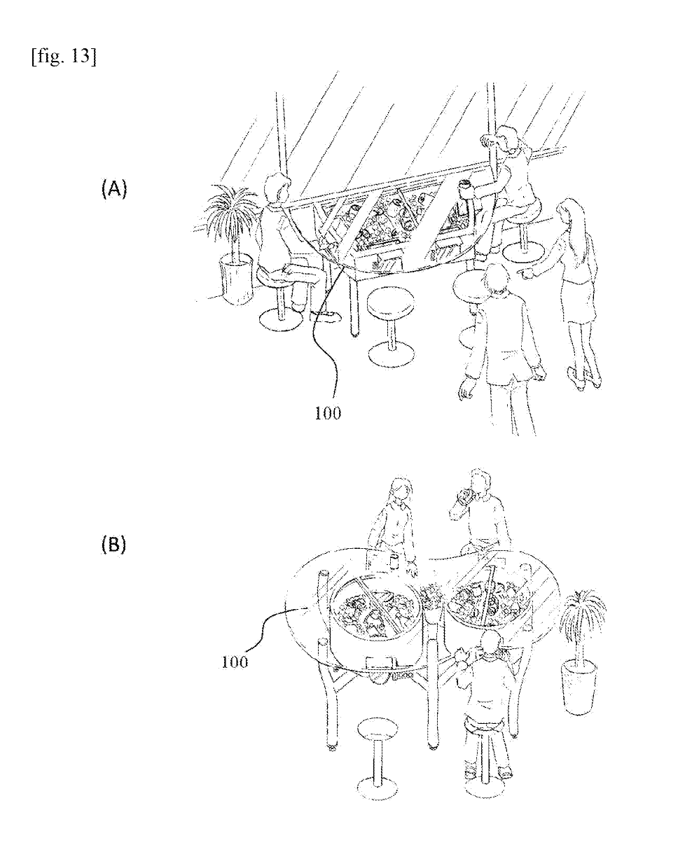

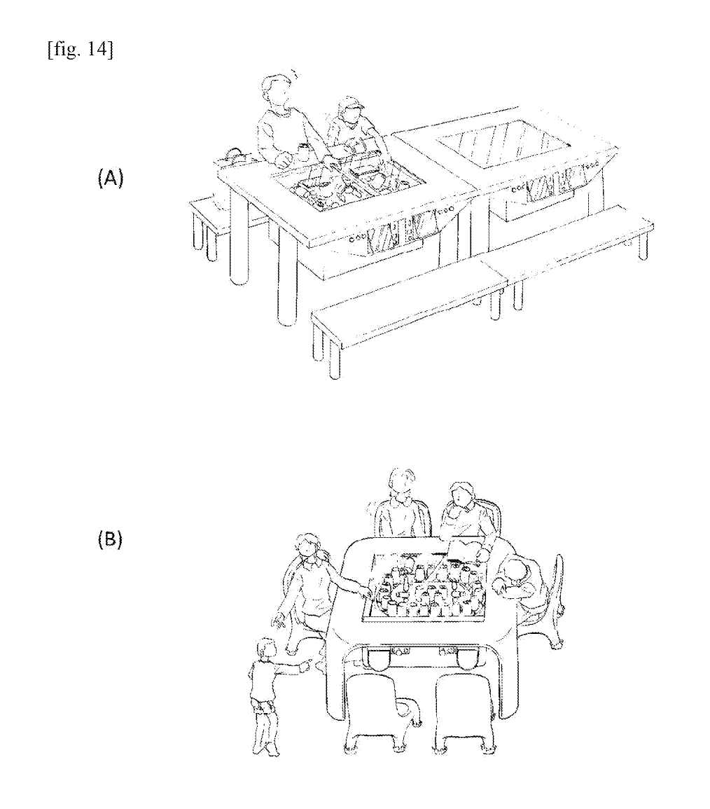

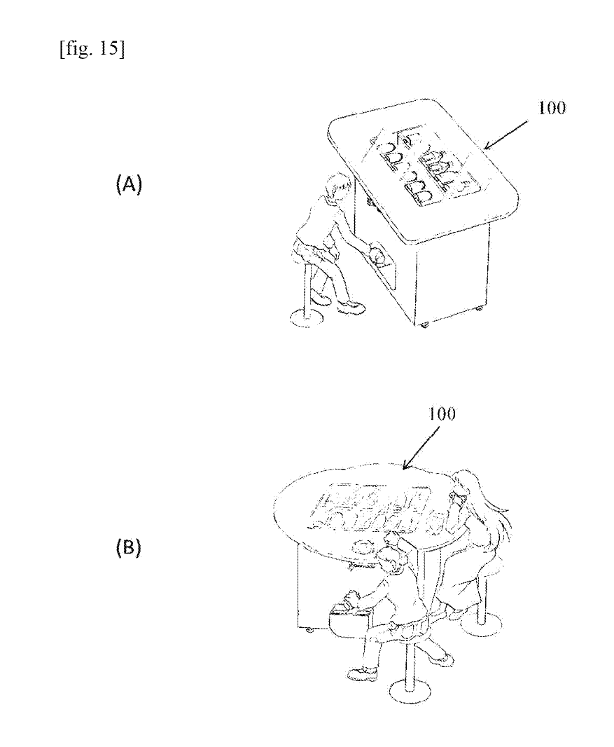

FIG. 15 is a figure showing the use state of vending machine-integrated table 100 of the present invention from FIG. 13. Because it can be used as a table, vending machine-integrated table 100 of the present invention, it can eat with top 103 of vending machine-integrated table 100 as shown in FIG. 13 (A), FIG. 13 (B), and it can be enjoyed as the gaming machine which acquires a product as shown in FIG. 14 (A), (B) (it is meant that it is transported to a product takeoff opening.). Even more particularly, as shown in FIG. 15 (A), FIG. 15 (B), needless to say, it can be used as a vending machine.

### INDUSTRIAL APPLICABILITY

Because the main body of table and a vending machine are configured as a unity, the present invention does not require an exclusive domain to install a vending machine. It can be shared with the domain where the main body of table is only installed in, and a domain to install a vending machine. Therefore, it becomes useful for the user who wants to install a vending machine because a vending machine can be installed if the domain where the main body of table is only installed in can be secured. Thus, the industrial applicability is big.

### LEGEND

100: vending machines-integrated table
101: main body of table
103: top
110: vending machine
111: product receiving area
104: leg portion
105: seats
115: product takeoff opening

1. A Vending machine-integrated table, comprising:
a main body of table having at least top;
a vending machine under the top;
one of a displaying and receiving means and window part;
said displaying and receiving means is provided to the top, displaying a product which can be sold with the vending machine, and accepting a instructions from a user;
said window part is viewing a product receiving area accommodated the product; and
a product transporting means; provided to the vending machine, transporting the product accommodated by the product receiving area into a product takeoff opening provided in the product receiving area.

2. The vending machine-integrated table of claim 1 provided in the displaying and receiving means, wherein the displaying and receiving means is configured to display the state that a product accommodated by the product receiving area is transported to the product takeoff opening when the displaying and receiving means accepts the instructions from a user.

3. The vending machine-integrated table of claim 2 further comprising an indication instructions means directing to display the product which can be sold with the vending machine to the displaying and receiving means.

4. The vending machine-integrated table of claim 1 which a window part was comprised to the top, further comprising a shutter provided in the top, changing the product receiving area from the window part from the state being impossible of viewing to the state being possible of viewing.

5. The vending machine-integrated table of claim 1 which a window part was comprised to the top, further comprising a rail for the internal circumference of the product receiving area; and
wherein the product transporting means includes a support moving along the rail by the operation of the user; and a holding means provided on the support, moving over the support, be hung up-and-down motion operatively, and holding a product accommodated by the product receiving area.

6. The vending machine-integrated table of claim 1 which a window part was comprised to the top, wherein the horizontal section shape of the product receiving area is circular;
a rail for the internal circumference of the product receiving area;
wherein the product transporting means includes:
a axis provided the center of the product receiving area, and be rotatable by the operation of the user;
a support pivotally supported by the axle, moving along the rail, and having a length corresponding to the horizontal distance from the axis to the rail; and
a holding means provided on the support, moving over the support, be hung up-and-down motion operatively, and holding a product accommodated by the product receiving area.

7. The vending machine-integrated table of claim 5 wherein the holding means comprises a pair of pick-shaped members gripping the product.

8. The vending machine-integrated table of claim 5 wherein the holding means comprises a shovel-shaped member scooping the product, and gripping.

9. The vending machine-integrated table of claim 5 wherein the holding means comprising:
a pump flowing out or flowing into of the air:
a hose that one end was connected to the pump:
a tool for absorption connected to the another end of the hose, being configured to be enabled to flow out or flow into of the air, being configured to be enabled to absorb the product from a tip of the tool for absorption through the hose.

10. The vending machine-integrated table of claim 1 which a window part was comprised to the top, wherein the product transporting means comprising:
a conveyer rail provided in product receiving area, driven by a endless conveyer;
a extrusion means extruding a product designated by user to a product takeoff opening, when a product designated by user transported near the product takeoff opening product among located to the conveyer.

11. The vending machine-integrated table of claim 1 further comprising a leg portion provided to the main body of table, and a seat provided to the leg portion.
